(19) United States
(12) Patent Application Publication
(10) Pub. No.: US 2007/0266229 A1
(43) Pub. Date: Nov. 15, 2007

(54) Encoding hardware end loop information onto an instruction

(76) Inventors: Erich Plondke, Austin, TX (US); Robert A. Lester, Round Rock, TX (US); Lucian Codrescu, Austin, TX (US); Muhammad Ahmed, Dallas, TX (US)

Correspondence Address: QUALCOMM INCORPORATED, 5775 MOREHOUSE DR., SAN DIEGO, CA, 92121, US

(21) Appl. No.: 11/431,732

(22) Filed: May 10, 2006

(51) Int. Cl. G06F 9/44

(52) U.S. Cl. 712/241

(57) ABSTRACT

Methods and apparatus for encoding information regarding a hardware loop of a set of packets is provided, each packet (400) containing instructions. The information is encoded into one or more bits of at least one instruction (300) in the set of packets. The information may indicate whether a packet is or is not an end packet of the loop. Information regarding two hardware loops may be encoded where information regarding the first loop is encoded into an instruction at a first position in each packet and information regarding the second loop is encoded into an instruction at a second position in each packet. End instruction information may be encoded into an instruction not having encoded loop information at the same bit positions reserved for the encoded loop information, the end instruction information indicating whether an instruction is the last instruction of a packet and the length of a packet.

### BACKGROUND

1. Field

The present embodiments relates generally to hardware loops, and more specifically to encoding hardware end loop information onto an instruction.

2. Background

Currently a widely used computer architecture is the Very Long Instruction Word (VLIW) architecture. Under a VLIW architecture, instructions are grouped in packets of one or more instructions and read and executed in parallel. A VLIW architecture uses several execution units or arithmetic logic units (ALUs) which enables the architecture to execute the instructions of a packet simultaneously, each execution unit or ALU being able to execute particular types of instructions. The maximum number of instructions in a packet is typically determined by the number of execution units or ALUs that are available for processing instructions. For example, if there are four execution units or ALUs available for processing instructions, a maximum of four instructions is typically allowed per packet. This allows each instruction of the packet to be processed in parallel so that no instruction waits on the processing of another instruction in the packet to finish. For a VLIW architecture, encoding software (e.g., a compiler, assembler tool, etc.) can be used to group instructions into packets of one or more instructions (where instructions of a same packet are not dependent on each other so they may be performed in parallel) and encode the packets to produce executable code.

A set of instructions or packets are often designated in a “loop” so that the instructions or packets are repeated a particular number of iterations. An instruction or packet loop can be implemented in software or hardware. When implemented in software, extra instructions are used to specify the loop (e.g., such as arithmetic, compare, and branching type instructions).

When implemented in hardware, typically registers are used to store memory addresses of start and end instructions or packets of the loop and to store the loop count. The registers are then used to determine when the end of the loop has been reached, to keep track of the loop count, and to return to the start of the loop until the desired number of loops/repetitions has been performed.

Under a VLIW architecture, a hardware loop comprises a set of one or more packets that are repeated a particular number of times. Conventionally, under a VLIW architecture, information specifying a hardware loop is contained in a separate header section of a packet. Other known methods include having a separate dedicated instruction in a packet that specifies hardware loop information. Header data or separate loop instructions, however, increases data overhead and processing time for the packet. There is therefore a need in the art for a method for encoding hardware loop information requiring less data and processing overhead.

### SUMMARY

Some aspects disclosed provide a method and apparatus for encoding information regarding at least one hardware loop, the hardware loop comprising a set of packets (including a start and end packet) to be executed a particular number of iterations, each packet containing one or more instructions and each instruction comprising a set of bits. In some aspects, the hardware loop information is encoded into one or more bits (at one or more predetermined bit positions) of at least one designated instruction in the set of packets. The at least one designated instruction comprises an instruction that is not originally used to specify a hardware loop (i.e., is an instruction that does not originally relate to a hardware loop).

A hardware loop has a start packet and an end packet that define the boundaries of the loop. In some aspects, the encoded hardware loop information comprises end packet information where information encoded in a designated instruction of a particular packet indicates that the particular packet is an end packet of the hardware loop or indicates that the particular packet is not an end packet of the hardware loop (thus also indicating to continue forward and process the next packet). In these aspects, a designated instruction containing end of loop information is an instruction that is not used to specify an end packet of the hardware loop (i.e., is not an end loop instruction).

In some aspects, the hardware loop information is not encoded at the beginning of a designated instruction, but rather is encoded within the bits of the designated instruction so that bits of the designated instruction are before and after the bits of the encoded hardware loop information. For example, if each instruction contains 32 bits, the hardware loop information may be encoded in the middle bits (e.g., the 15th and 16th bits) of the designated instruction where the remaining bits (e.g., the 1st through 14th bits and the 17th through 32nd bits) of the designated instruction are used to specify the designated instruction.

In some aspects, the set of packets are a set of Very Long Instruction Word (VLIW) packets and the hardware loop information is encoded into an instruction at a predetermined position in each VLIW packet of the set of VLIW packets. For example, the hardware loop information may be encoded into the first instruction of each VLIW packet.

In some aspects, information regarding two hardware loops is encoded where information regarding the first hardware loop is encoded into an instruction at a first predetermined position in each packet and information regarding the second hardware loop is encoded into an instruction at a second predetermined position in each packet. For example, the information regarding the first hardware loop may be encoded into the first instruction of each packet and the information regarding the second hardware loop may be encoded into the second instruction of each packet.

In some aspects, end instruction information is encoded into at least one instruction of a packet that does not have encoded hardware loop information. In these aspects, the end instruction information is encoded in the same predetermined bit positions reserved for the encoded hardware loop information. The encoded end instruction information indicates whether an instruction is the last instruction of the packet (and thus also indicates the length of the packet, i.e., how many instructions the packet contains).

### BRIEF DESCRIPTION OF THE DRAWINGS

FIG. 1 shows a conceptual diagram of a compilation process that produces encoded VLIW packets;

FIG. 2 shows a conceptual diagram of a Very Long Instruction Word (VLIW) computer architecture;

FIG. 3 is a conceptual diagram of an instruction of a packet designated to contain encoded hardware loop information;

FIG. 4 shows a conceptual diagram of an exemplary packet having two instructions;

FIG. 5 shows a conceptual diagram of an exemplary packet having three instructions;

FIG. 6 shows a conceptual diagram of a an exemplary packet having four or more instructions;

FIG. 7 shows an exemplary table of all variations of values for encoded end loop and end instruction information for packets having a maximum of four instructions;

FIG. 8 is a flowchart of a method for encoding hardware loop information into one or more instructions of a packet in the hardware loop; and

FIG. 9 shows a conceptual diagram of a Very Long Instruction Word (VLIW) computer architecture used for a digital signal processor (DSP) in some embodiments.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

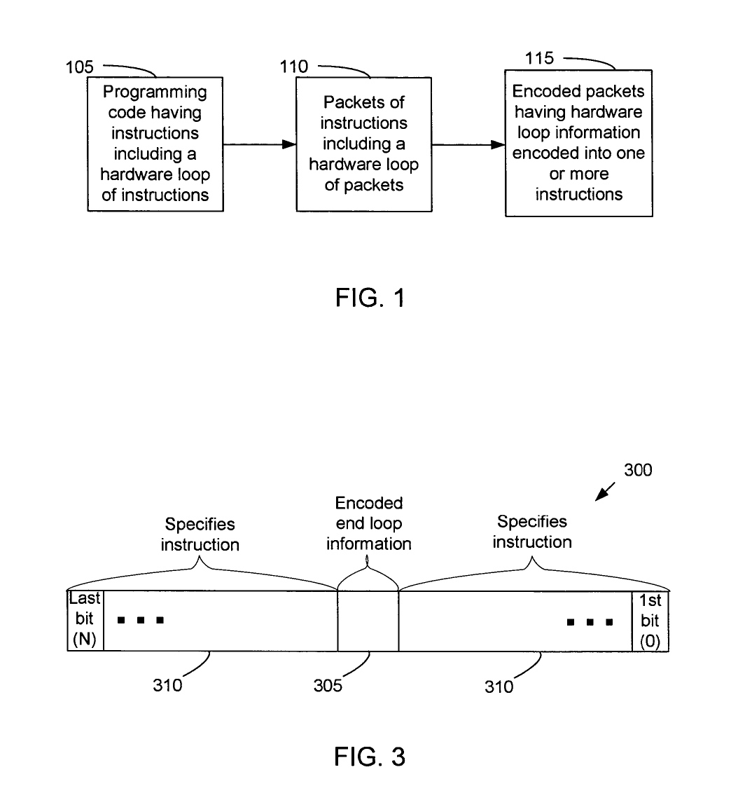

FIG. 1 shows a conceptual diagram of a compilation process that produces encoded VLIW packets. As shown in FIG. 1, programming code 105 is first created (e.g., by a programmer) that specifies a plurality of instructions. Each instruction specifies a particular computation or operation (such as shift, multiply, load, store, etc.). In some embodiments, the plurality of instructions include hardware loop instructions that specify a set of instructions to be performed a particular number of times (i.e., executed a particular number of iterations), the set of instructions comprising a hardware loop.

The instructions in the programming code are then grouped into packets of one or more instructions (e.g., by a programmer or a VLIW compiler) to produce packets of instructions 110. The instructions are grouped so that instructions of the same packet do not have dependencies (and thus can be executed in parallel). The maximum number of instructions in a packet is typically determined by the number of execution units or ALUs that are available in a device for processing instructions. The set of instructions of the hardware loop are also grouped into packets to produce a hardware loop comprising a set of one or more packets (including a start packet and an end packet) to be performed a particular number of times. An end packet of a hardware loop is typically marked by an indicator (such as “endloop” in assembly syntax).

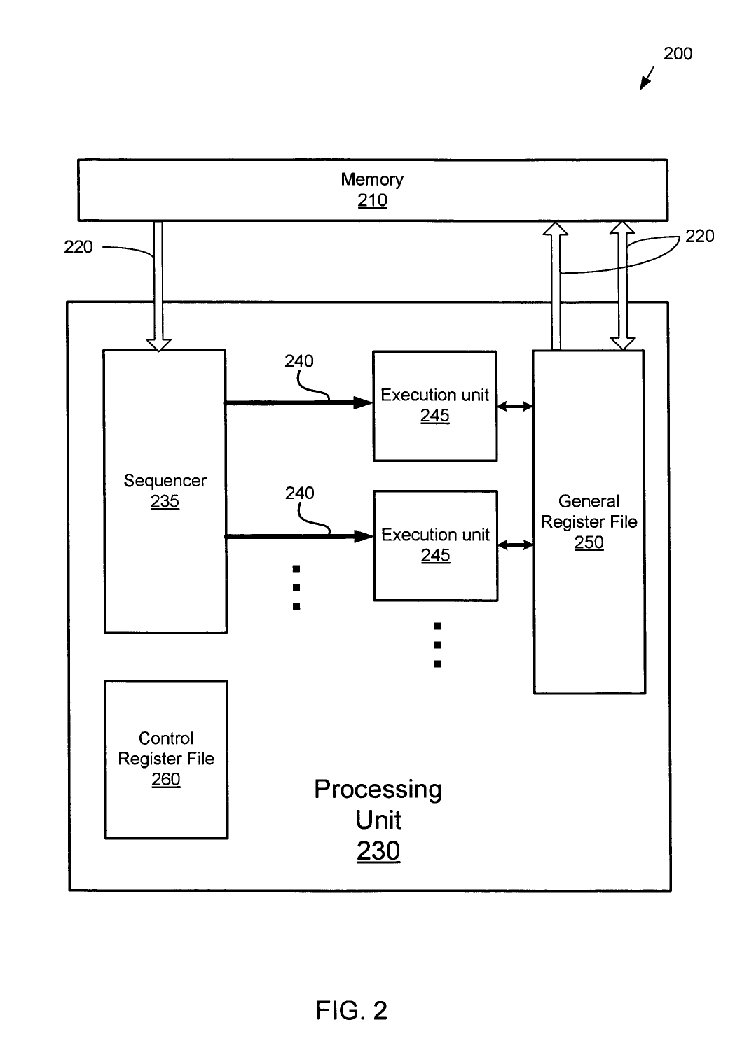

The packets of instructions (source code) are then compiled by a VLIW compiler into encoded packets of instructions 115 in binary code (object code). Each instruction comprises a predetermined number of bits; for example, each instruction may have a 32-bit word width. When encoding one or more instructions in a packet, the instructions are encoded serially to essentially produce a single larger encoded instruction (i.e., an encoded VLIW packet). Each instruction in the packet has a particular ordering or position (first, second, third, etc.) relative to the other instructions in the packet and are stored to memory according to their ordering or position (as discussed below in relation to FIG. 2). For example, a first instruction of a packet is typically stored in a lower memory address than a second instruction of the packet, which has a lower memory address than a third instruction of the packet, etc.

When the VLIW compiler receives the hardware loop of packets, the VLIW compiler must also encode information regarding the hardware loop. For example, the VLIW compiler may receive a packet marked as an end packet of a hardware loop (e.g., by “endloop” in assembly syntax). In the prior art, information identifying an end packet was encoded in a separate header section of the end packet. Other known methods include having a separate encoded instruction in a packet that indicates that the packet is an end packet. Header data and separate end of packet instructions, however, increases data overhead and processing time for the packet.

In some embodiments, end packet information for a hardware loop of packets is encoded into one or more instructions of one or more packets in the hardware loop. In some embodiments, information indicating an end packet of a loop is encoded into an instruction of the end packet. As such, a separate header containing end packet information is no longer needed. Also, the end packet information is encoded into an instruction that is not an end loop instruction but rather an instruction specifying a different type of instruction (e.g., shift, multiply, load, etc.). As such, a separate end loop instruction is also not needed to indicate an end packet.

FIG. 2 shows a conceptual diagram of a Very Long Instruction Word (VLIW) computer architecture 200. The VLIW architecture 200 includes a memory 210, a processing unit 230, and one or more buses 220 coupling the memory 210 to the processing unit 230.

The memory 210 stores data and instructions (in the form of VLIW packets produced by a VLIW compiler, each VLIW packet comprising one or more instructions). Each instruction of a packet has a particular address in the memory 210 where the first instruction in a packet typically has a lower memory address than the last instruction of the packet. Addressing schemes for a memory are well known in the art and not discussed in detail here. Instructions in the memory 210 are loaded to the processing unit 230 via buses 220. Each instruction is typically of a predetermined width.

The processing unit 230 comprises a sequencer 235, a plurality of pipelines 240 for a plurality of execution units 245, a general register file 250 (comprising a plurality of general registers), and a control register file 260. The processing unit 210 may comprise a central processing unit, microprocessor, digital signal processor, or the like.

As discussed above, each VLIW packet comprises one or more instructions, the maximum number of instructions in a packet typically being determined by the number of execution pipelines, such as ALUs, that are available in the processing unit 230 for processing instructions. Typically, each instruction contains information regarding the type of execution unit needed to process the instruction where each execution unit can only process a particular type of instruction (e.g., shift, load, etc.). Therefore, there are only a particular number of execution units available to process a particular type of instruction. As such, instructions are grouped in a packet based on the types of instructions in the packet and the types of available execution units so the instructions can be performed in parallel. For example, if there is only one execution unit available that can process shift-type instructions and only two execution units available that can process load-type instructions, two shift-type instructions would not be grouped into the same packet, nor would three load-type instructions be grouped into the same packet.

The sequencer 235 receives packets of instructions from the memory 210 and determines the appropriate pipeline 240/execution unit 245 for each instruction (using the information contained in the instruction) of each received packet. After making this determination for each instruction of a packet, the sequencer 235 inputs the instructions into the appropriate pipeline 240 for processing by the appropriate execution unit 245.

Each execution unit 245 that receives an instruction performs the instruction using the general register file 250. As well known in the art, the general register file 250 comprises an array of registers used to load data from the memory 210 needed to perform an instruction. After the instructions of a packet are performed by the execution units 245, the resulting data is stored to the general register file 250 and then loaded and stored to the memory 210. Data is loaded to and from the memory 210 via buses 220. Typically the instructions of a packet are performed in parallel by a plurality of execution units 245 in one clock cycle.

To execute an instruction, an execution unit 245 may also use the control register file 260. Control registers 260 typically comprise a set of special registers, such as modifier, status, and predicate registers. Control registers 260 can also be used to store information regarding hardware loops, such as a loop count (iteration count) and a start loop (start packet) address. The hardware loop information stored in the control registers 260 can be used in conjunction with the encoded end loop (end packet) information, as described in some embodiments, to perform a hardware loop for a particular number of iterations. In particular, when an end packet is reached (as indicated by encoded end loop information in an instruction of the packet), the loop count is decremented and the loop returns to the start packet if the loop count is positive.

FIG. 3 is a conceptual diagram of an instruction 300 of a packet designated to contain encoded hardware loop information. In some embodiments, the designated instruction 300 containing the encoded hardware loop information is not an instruction that originally contained hardware loop information or was used to specify a hardware loop (i.e., was a non-hardware loop instruction, such as a shift or load instruction). The instruction 300 comprises a plurality of bits including a first bit (0), a last bit (N), and end loop information encoded in one or more bits 305 at one or more predetermined bit positions between the first and last bits of the instruction. Note that the remaining bits 310 specifying the designated instruction are positioned on either side (i.e., before and after) the bits of the encoded hardware loop information. For example, if the designated instruction is a shift instruction, bits specifying the shift instruction are positioned before and after the bits of the encoded hardware loop information.

In some embodiments, end packet information is encoded into the designated instruction 300, the designated instruction 300 being an instruction that did not originally contain end packet information or was used to specify an end packet of a hardware loop. In some embodiments, the end packet information encoded in a designated instruction 300 of a particular packet indicates (using a first binary code) that the particular packet is an end packet of the hardware loop or indicates (using a second binary code) that the particular packet is not an end packet of the hardware loop (thus also indicating to continue forward and process the next packet). For example, the 2-bit binary code “10” in the predetermined bit positions may indicate that the packet is an end packet and the 2-bit binary code “01” in the predetermined bit positions may indicate that the packet is not an end packet of a hardware loop.

As discussed above, each instruction in a packet has a particular ordering or position (first, second, third, etc.) relative to the other instructions of the packet. In some embodiments, the end loop information is encoded into an instruction (referred to as the designated instruction) at the same predetermined position (relative to the positions of the other instructions in the same packet) in each packet of the hardware loop. For example, the end loop information may be encoded into the first instruction of each packet in the hardware loop.

In some embodiments, information regarding two hardware loops are specified, the first hardware loop comprising a first set of packets to be executed a particular number of iterations and the second hardware loop comprising a second set of packets to be executed a particular number of iterations. For example, the first hardware loop may be an inner loop and the second hardware loop an outer loop that contains the inner loop. The first and second hardware loops may also be separate independent loops. In these embodiments, information regarding the first hardware loop is encoded into an instruction at a same first predetermined position in each packet of the first set of packets and information regarding the second hardware loop is encoded into an instruction at a same second predetermined position in each packet of the second set of packets. For example, end loop information for the first hardware loop may be encoded into the first instruction (the designated instruction) of each packet in the first hardware loop and end loop information for the second hardware loop may be encoded into the second instruction (the designated instruction) of each packet in the second hardware loop.

In some embodiments, a packet containing end loop information for a first hardware loop contains two or more instructions. If there is only one instruction in such a packet, NOP instructions are added to achieve at least two instructions. In these embodiments, the last instruction of the packet contains encoded information (end instruction information) in one or more bits at one or more predetermined bit positions that indicate it is the last instruction of the packet (and thus also indicates the length of the packet, i.e., how many instructions the packet contains). In some embodiments, the end instruction information is encoded into an instruction that does not have encoded hardware loop information and is encoded in the same predetermined bit positions reserved for the encoded hardware loop information.

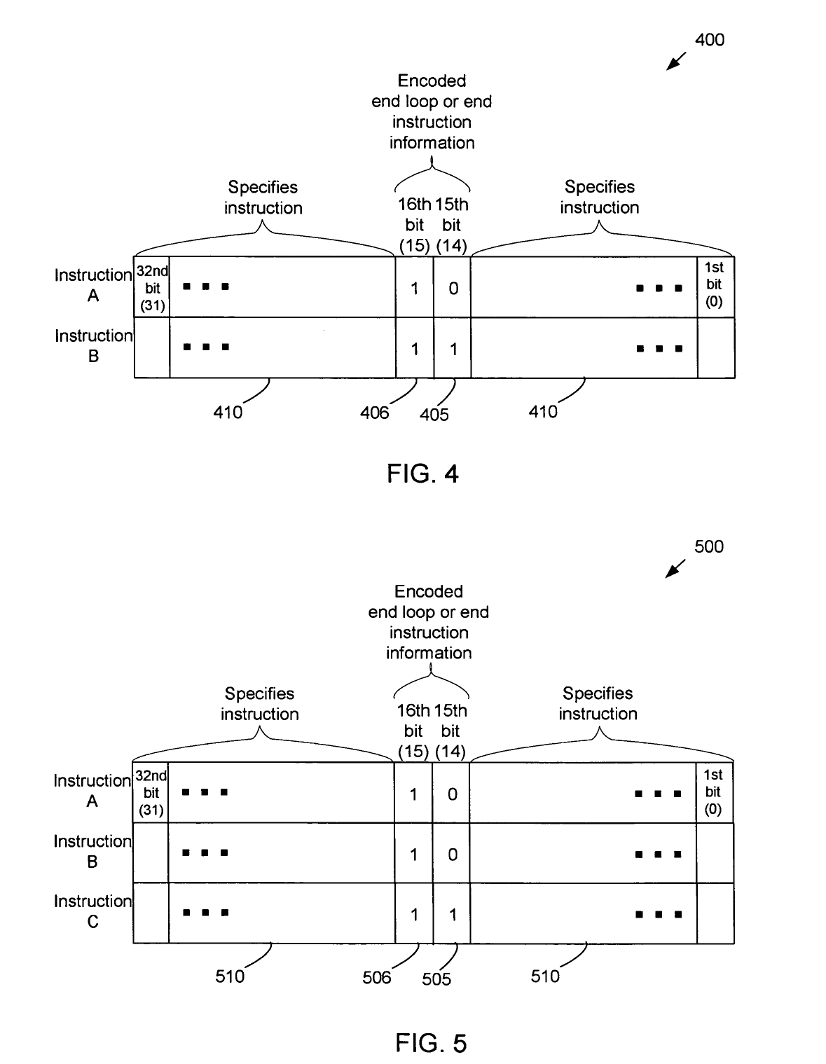

FIG. 4 shows a conceptual diagram of an exemplary packet 400 having a first instruction (instruction A) and a second instruction (instruction B). In the example of FIG. 4, each instruction comprises 32 bits where end loop or end packet information is encoded into the 15^{th} and 16^{th} bits 405 and 406 (bit numbers 14 and 15) of the instructions. The remaining bits 410 of each instruction (i.e., the 1^{st} through 14^{th} bits and the 17^{th} through 32^{nd} bits) are used to specify the actual instruction (e.g., multiply operation, load operation, etc.). In other embodiments, instructions may have other bit widths and/or encoded information may be contained in other bits of the instructions. In the example of FIG. 4, end loop information regarding the first hardware loop is encoded into the first instruction (e.g., where the binary code “10” indicates that the packet 400 is an end packet) and end instruction information is encoded into the last instruction (e.g., where the binary code “11” indicates that instruction B is the last instruction of the packet 400).

In some embodiments, a packet containing end loop information (in a designated instruction) for a second hardware loop contains three or more instructions. If there is only one or two instructions in such a packet, NOP instructions are added to achieve at least three instructions. In these embodiments, the last instruction of the packet contains encoded information (end instruction information) in one or more bits at one or more predetermined bit positions that indicate it is the last instruction of the packet (and thus also indicates the length of the packet, i.e., how many instructions the packet contains). In some embodiments, the end instruction information is encoded into an instruction that does not have encoded hardware loop information and is encoded in the same predetermined bit positions reserved for the encoded hardware loop information.

FIG. 5 shows a conceptual diagram of an exemplary packet 500 having a first instruction (instruction A), a second instruction (instruction B), and a third instruction (instruction C). In the example of FIG. 5, each instruction comprises 32 bits where end loop or end packet information is encoded into the 15^{th} and 16^{th} bits 505 and 506 of the instructions. The remaining bits 510 of each instruction are used to specify the actual instruction. In the example of FIG. 5, end loop information regarding the first hardware loop is encoded into the first instruction, end loop information regarding the second hardware loop is encoded into the second instruction (e.g., where the binary code “10” indicates that the packet 500 is an end packet of the second hardware loop), and end instruction information is encoded into the last instruction.

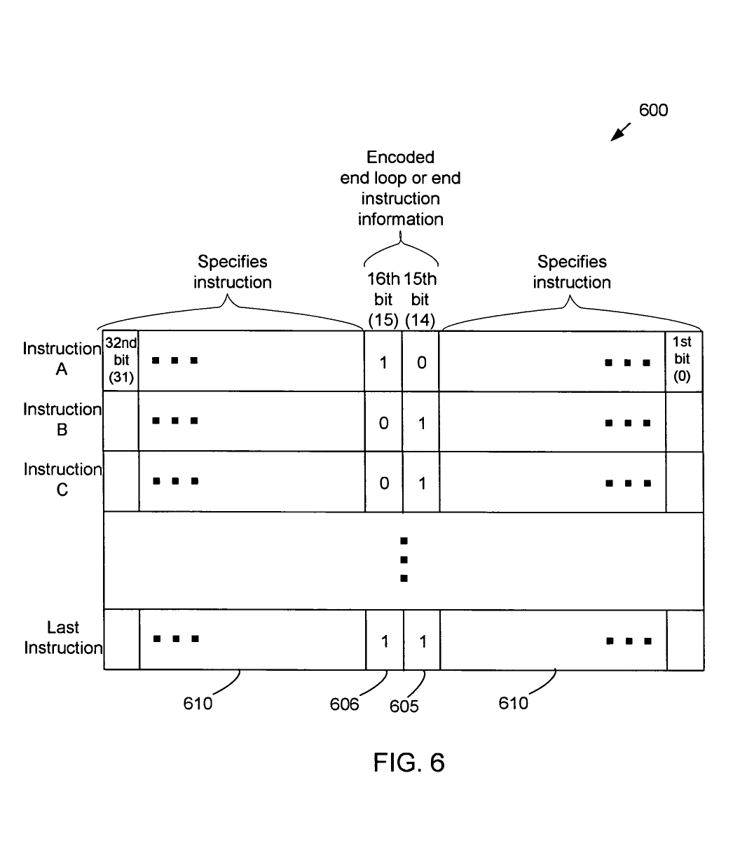

For packets containing four or more instructions, instructions in a packet not designated to contain encoded end loop or end packet information may contain (at the same predetermined bit positions reserved for the encoded end loop and end instruction information) meaningless binary code which can be any code except for the code used to indicate the last instruction of a packet. FIG. 6 shows a conceptual diagram of a an exemplary packet 600 having four or more instructions (instructions A, B, C, etc.). In the example of FIG. 6, each instruction comprises 32 bits where end loop or end packet information is encoded into the 15^{th} and 16^{th} bits 605 and 606 of the instructions. The remaining bits 610 of each instruction are used to specify the actual instruction. In the example of FIG. 6, end loop information regarding first and second hardware loops are encoded into the first and second instructions (instructions A and B) and end instruction information is encoded into the last instruction. The remaining instructions (e.g., instruction C) typically may contain any binary code (except the code used to indicate the last instruction of a packet) at the same predetermined bit positions (e.g., the 15^{th} and 16^{th} bits), since the code at these bit positions will not be meaningful in the remaining instructions. Note that in the packets 400, 500, and 600 shown in FIGS. 4 through 6, a header is not included.

In some embodiments, the same one or more predetermined bit positions in each instruction of a set of packets are reserved for encoded end loop information, end packet information, or meaningless information (null code). In the examples shown above in FIGS. 4 through 6, the 15^{th} and 16^{th} bits of each instruction (of a 32-bit instruction) were reserved for this type of information. In other embodiments, instructions may have other bit widths and/or encoded information may be contained in other bit positions of the instructions. The remaining bits of each instruction (i.e., the non-reserved bits) are used to specify the actual instruction (e.g., multiply operation, load operation, etc.).

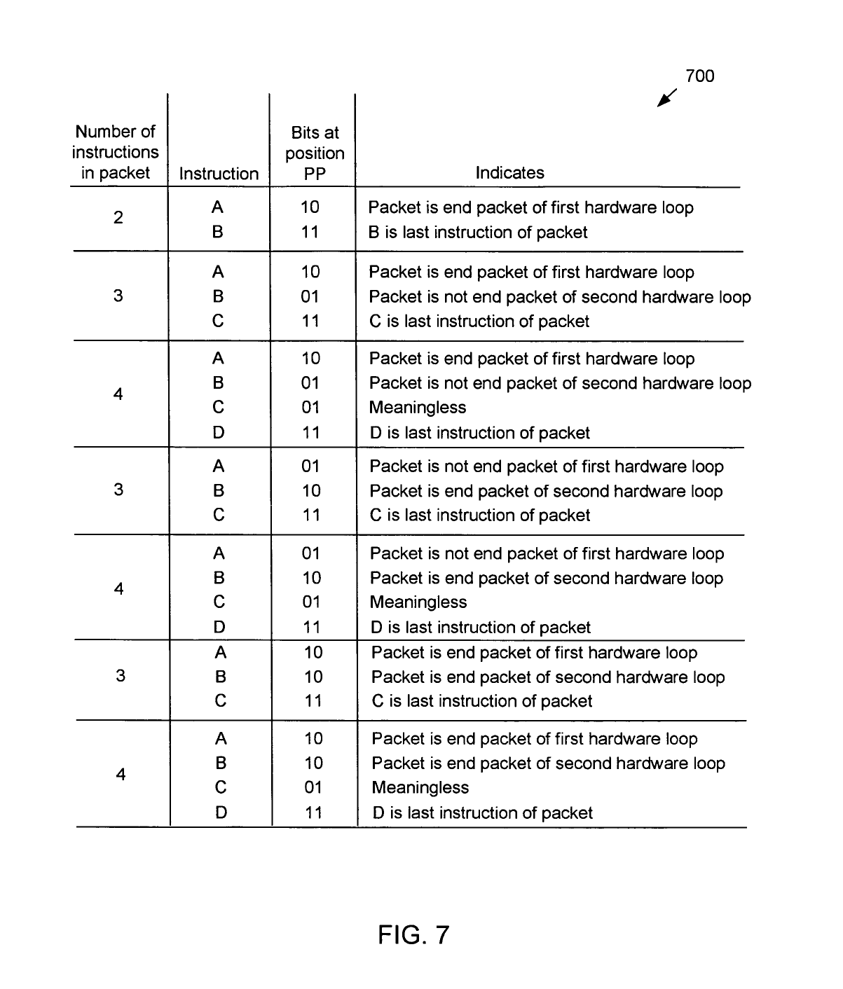

FIG. 7 shows an exemplary table of all variations of values for encoded end loop and end instruction information for packets having a maximum of four instructions. For the example table of FIG. 7, note the following:

instruction A is a first instruction in a packet (having a lowest memory address in the packet), instruction B is a second instruction in a packet (having a second lowest memory address in the packet), instruction C is a third instruction in a packet (having a second highest memory address in the packet), and instruction D is a fourth instruction in a packet (having a highest memory address in the packet);

end loop information, end instruction information, and meaningless information are encoded as a 2-bit binary code into the same reserved bit positions “PP” in each instruction;

end loop information for a first hardware loop is encoded into the first instruction (instruction A) of each packet where the binary code “10” indicates that the packet is an end packet and the binary code “01” indicates that the packet is not an end packet of the first hardware loop;

end loop information for a second hardware loop is encoded into the second instruction (instruction B) of each packet where the binary code “10” indicates that the packet is an end packet and the binary code “01” indicates that the packet is not an end packet of the second hardware loop; and

end instruction information is encoded into the last instruction of each packet where the binary code “11” indicates that the instruction is the last instruction of the packet (and thus also indicates the length of the packet, i.e., how many instructions the packet contains).

In other embodiments, however, packets may have more than a maximum of four instructions, end loop and end instruction information may be encoded with a different number of bits, end loop information for the first hardware loop may be encoded into a different instruction than the first instruction, end loop information for the second hardware loop may be encoded into a different instruction than the second instruction, different binary codes may be used to indicate that a packet is or is not an end packet, or a different binary code may be used to indicate a last instruction of a packet.

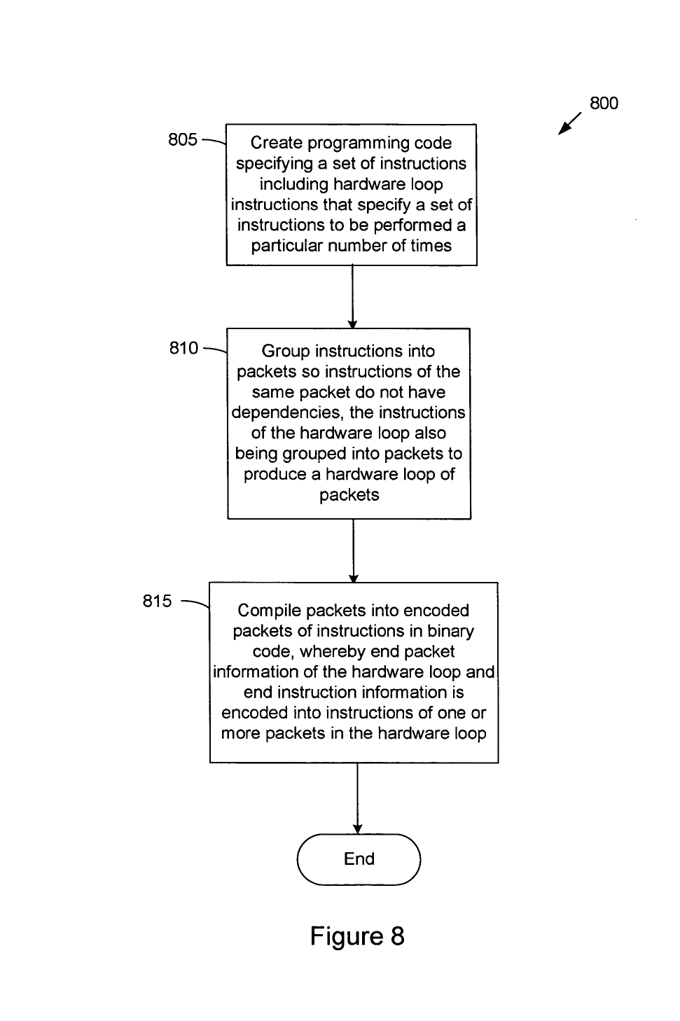

FIG. 8 is a flowchart of a method 800 for encoding hardware loop information into one or more instructions. In some embodiments, some steps of the method 800 are implemented in hardware or software, for example, by a VLIW compiler. The steps of the method 800 are for illustrative purposes only and the order or number of steps may vary or be interchanged in other embodiments.

The method 800 begins when programming code is created (at 805) that specifies a plurality of instructions including hardware loop instructions that specify a set of instructions to be performed a particular number of times (i.e., executed a particular number of iterations). The set of instructions comprises a hardware loop.

The instructions in the programming code are then grouped (at 810) into packets of one or more instructions. The instructions are grouped so that instructions of the same packet do not have dependencies and can be executed in parallel. The set of instructions of the hardware loop are also grouped into packets to produce a hardware loop comprising a set of packets to be performed a particular number of times, the end packet of the hardware loop being marked by an indicator (such as “endloop” in assembly syntax).

The packets of instructions (source code) are then compiled (at 815) into encoded packets of instructions in binary code (object code). When encoding end packet information of the hardware loop, the method 800 encodes the end packet information into one or more instructions of one or more packets in the hardware loop. In some embodiments, end loop information regarding a first loop is encoded into an instruction at a first predetermined position in the packet and end loop information regarding a second loop is encoded into an instruction at a second predetermined position in the packet. End instruction information is also encoded into at least one instruction of a packet that does not have encoded hardware loop information, the end instruction information being encoded in the same predetermined bit positions reserved for the encoded hardware loop information. The method 800 then ends.

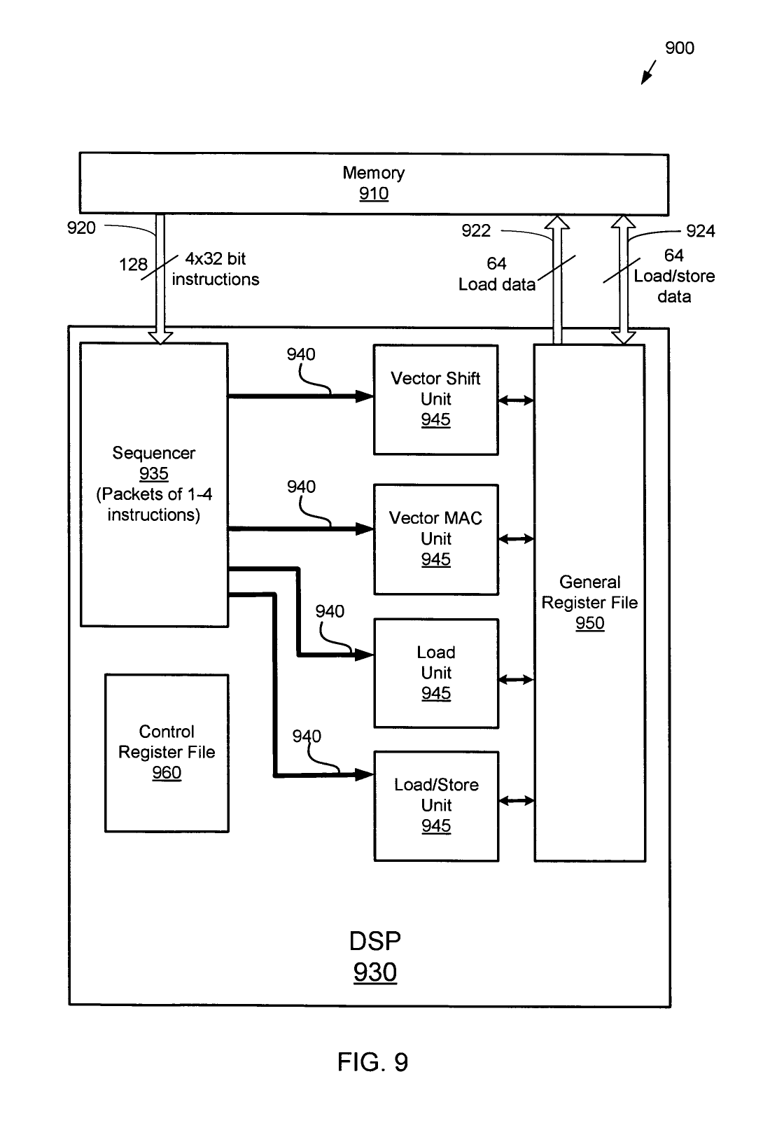

FIG. 9 shows a conceptual diagram of a Very Long Instruction Word (VLIW) computer architecture 900 used for a digital signal processor (DSP) in some embodiments. The VLIW architecture 900 includes a memory 910 and a DSP 930 with an instruction load bus 920, a data load bus 922, and a data load/store bus 924 coupling the memory 910 to the DSP 930.

The memory 910 stores data and instructions (in the form of VLIW packets having one to four instructions). Instructions in the memory 910 are loaded to the DSP 930 via the instruction load bus 920. In some embodiments, each instruction has a 32-bit word width which is loaded to the DSP 930 via a 128-bit instruction load bus 920 having 4 word width. In some embodiments, the memory 910 is a unified byte-addressable memory, has 32-bit address space storing both instructions and data, and operates in little-endian mode.

The DSP 930 comprises a sequencer 935, four pipelines 940 for four logical execution units 945, a general register file 950 (comprising a plurality of general registers), and a control register file 960. Typically, when there are four pipelines 940 available, from a programmer's perspective, there are four “slots” available for processing instructions. From the hardware perspective, however, there is also an additional execution unit available for processing branch type instructions, where the additional execution unit may be issued from a subset of the “slots”. The sequencer 935 receives packets of instructions from the memory 910 and determines the appropriate pipeline 940/execution unit 945 for each instruction (using the information contained in the instruction) of each received packet. After making this determination for each instruction of a packet, the sequencer 935 inputs the instructions into the appropriate pipeline 940 for processing by the appropriate execution unit 945.

The execution units 945 comprise a vector shift unit, a vector MAC unit (for multiply instructions), a load unit, and a load/store unit. The vector shift unit executes shift instructions, such as S-type (shifting and bit-manipulation), A64-type (complex arithmetic), A32-type (simple arithmetic), J-type (change-of-flow or jump/branch), and CR-type (involves control registers) instructions. The vector MAC unit executes multiply instructions, such as M-type (multiply), A64-type, A32-type, J-type, and JR-type (change-of-flow instructions that involve a register) instructions. The load unit loads and reads data from the memory 910 to the general register file 950 and executes load-type and A32-type instructions. The load/store unit reads and stores data from the general register file 950 back to the memory and executes load-type, store-type, and A32-type instructions. Additionally, each execution unit 945 can typically execute many common arithmetic and logical operations.

Each execution unit 945 that receives an instruction performs the instruction using the general register file 950 that is shared by the four execution units 945. In some embodiments, the general register file 950 comprises thirty-two 32-bit registers that can be accessed as single registers or as aligned 64-bit pairs (so that an instruction can operate on 32-bit or 64-bit values). Data needed by an instruction is loaded to the general register file 950 via a 64-bit data load bus 922. After the instructions of a packet are performed by the execution units 945, the resulting data is stored to the general register file 950 and then loaded and stored to the memory 910 via a 64-bit data load/store bus 924. Typically the one to four instructions of a packet are performed in parallel by the four execution units 945 in one clock cycle (where a maximum of one instruction is received and processed by a pipeline 940 for each clock cycle).

To execute an instruction, an execution unit 945 may also use the control register file 960. The control register file 960 comprises a set of special registers, such as modifier, status, and predicate registers. Control registers 960 can also be used to store information regarding hardware loops, such as a loop count (iteration count) and a start loop (start packet) address. The hardware loop information stored in the control registers 960 can be used in conjunction with the encoded end loop (end packet) information, as described in some embodiments, to perform a hardware loop for a particular number of iterations.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer program product having a computer readable medium having instructions stored thereon which when executed encode information regarding at least one hardware loop comprising a set of packets to be executed a particular number of iterations, each packet comprising one or more instructions, each instruction comprising a set of bits, the computer program product comprising sets of instructions for:
encoding hardware loop information into one or more bits at one or more reserved bit positions of at least one designated instruction in the set of packets, wherein the at least one designated instruction comprises an instruction that is not used to specify a hardware loop.

2. The computer program product of claim 1 wherein:
the encoded hardware loop information comprises end of hardware loop packet information; and
the at least one designated instruction comprises an instruction that is not used to specify an end packet of the hardware loop.

3. The computer program product of claim 2 wherein:
the end of loop information encoded in a designated instruction of a particular packet indicates that the particular packet is an end packet of the hardware loop or indicates that the particular packet is not an end packet of the hardware loop.

4. The computer program product of claim 1 wherein the hardware loop information is encoded within the bits of the designated instruction so that bits specifying the designated instruction are before and after the bits of the encoded hardware loop information.

5. The computer program product of claim 4 wherein:
each instruction comprises 32 bits;
the hardware loop information is encoded in the 15^{th} and 16^{th} bits of the designated instruction; and
the 1^{st} through 14^{th} bits and the 17^{th} through 32^{nd} bits of the designated instruction specify the designated instruction.

6. The computer program product of claim 1 wherein:
the set of packets are a set of Very Long Instruction Word (VLIW) packets; and
the hardware loop information is encoded into an instruction at a same predetermined position in each VLIW packet of the set of VLIW packets.

7. The computer program product of claim 1 wherein:
the at least one hardware loop comprises a first loop comprising a first set of packets to be executed a particular number of iterations and a second loop comprising a second set of packets to be executed a particular number of iterations;
hardware loop information regarding the first loop is encoded into an instruction at a first predetermined position in each packet of the first set of packets; and hardware loop information regarding the second loop is encoded into an instruction at a second predetermined position in each packet of the second set of packets.

8. The computer program product of claim 1, further comprising a set of instructions for:
encoding end instruction information into at least one instruction in the set of packets not having encoded hardware loop information, the end instruction information being encoded in the same bit positions reserved for the encoded hardware loop information, wherein the encoded end instruction information indicates whether an instruction is the last instruction of a packet and indicates the length of a packet.

9. A method for encoding information regarding at least one hardware loop comprising a set of packets to be executed a particular number of iterations, each packet comprising one or more instructions, each instruction comprising a set of bits, the method comprising:
encoding hardware loop information into one or more bits at one or more reserved bit positions of at least one designated instruction in the set of packets, wherein the at least one designated instruction comprises an instruction that is not used to specify a hardware loop.

10. The method of claim 9 wherein:
the encoded hardware loop information comprises end of hardware loop packet information; and
the at least one designated instruction comprises an instruction that is not used to specify an end packet of the hardware loop.

11. The method of claim 10 wherein:
the end of loop information encoded in a designated instruction of a particular packet indicates that the particular packet is an end packet of the hardware loop or indicates that the particular packet is not an end packet of the hardware loop.

12. The method of claim 9 wherein the hardware loop information is encoded within the bits of the designated instruction so that bits specifying the designated instruction are before and after the bits of the encoded hardware loop information.

13. The method of claim 12 wherein:
each instruction comprises 32 bits;
the hardware loop information is encoded in the 15^{th} and 16^{th} bits of the designated instruction; and
the 1^{st} through 14^{th} bits and the 17^{th} through 32^{nd} bits of the designated instruction specify the designated instruction.

14. The method of claim 9 wherein:
the set of packets are a set of Very Long Instruction Word (VLIW) packets; and
the hardware loop information is encoded into an instruction at a same predetermined position in each VLIW packet of the set of VLIW packets.

15. The method of claim 9 wherein:
the at least one hardware loop comprises a first loop comprising a first set of packets to be executed a particular number of iterations and a second loop comprising a second set of packets to be executed a particular number of iterations;
hardware loop information regarding the first loop is encoded into an instruction at a first predetermined position in each packet of the first set of packets; and
hardware loop information regarding the second loop is encoded into an instruction at a second predetermined position in each packet of the second set of packets.

16. The method of claim 9, further comprising:
encoding end instruction information into at least one instruction in the set of packets not having encoded hardware loop information, the end instruction information being encoded in the same bit positions reserved for the encoded hardware loop information, wherein the encoded end instruction information indicates whether an instruction is the last instruction of a packet and indicates the length of a packet.

17. An apparatus for processing instructions, the apparatus comprising:
a memory for storing packets comprising one or more instructions, each instruction comprising a set of bits, the instructions specifying at least one hardware loop comprising a set of packets to be executed a particular number of iterations, wherein hardware loop information is encoded into one or more bits at one or more reserved bit positions of at least one designated instruction in the set of packets, wherein the at least one designated instruction comprises an instruction that is not used to specify a hardware loop; and
a processing unit coupled to the memory for receiving and executing the packets of instructions, wherein the instructions of a packet are processed in parallel.

18. The apparatus of claim 17 wherein:
the encoded hardware loop information comprises end of hardware loop packet information; and
the at least one designated instruction comprises an instruction that is not used to specify an end packet of the hardware loop.

19. The apparatus of claim 18 wherein:
the end of loop information encoded in a designated instruction of a particular packet indicates that the particular packet is an end packet of the hardware loop or indicates that the particular packet is not an end packet of the hardware loop.

20. The apparatus of claim 17 wherein the hardware loop information is encoded within the bits of the designated instruction so that bits specifying the designated instruction are before and after the bits of the encoded hardware loop information.

21. The apparatus of claim 20 wherein:
each instruction comprises 32 bits;
the hardware loop information is encoded in the 15^{th} and 16^{th} bits of the designated instruction; and
the 1^{st} through 14^{th} bits and the 17^{th} through 32^{nd} bits of the designated instruction specify the designated instruction.

22. The apparatus of claim 17 wherein:
the set of packets are a set of Very Long Instruction Word (VLIW) packets; and
the hardware loop information is encoded into an instruction at a same predetermined position in each VLIW packet of the set of VLIW packets.

23. The apparatus of claim 17 wherein:
the at least one hardware loop comprises a first loop comprising a first set of packets to be executed a particular number of iterations and a second loop comprising a second set of packets to be executed a particular number of iterations;
hardware loop information regarding the first loop is encoded into an instruction at a first predetermined position in each packet of the first set of packets; and
hardware loop information regarding the second loop is encoded into an instruction at a second predetermined position in each packet of the second set of packets.

24. The apparatus of claim 17, wherein end instruction information is encoded into at least one instruction in the set of packets not having encoded hardware loop information, the end instruction information being encoded in the same bit positions reserved for the encoded hardware loop information, wherein the encoded end instruction information indicates whether an instruction is the last instruction of a packet and indicates the length of a packet.

25. An apparatus configured for encoding information regarding at least one hardware loop comprising a set of packets to be executed a particular number of iterations, each packet comprising one or more instructions, each instruction comprising a set of bits, the apparatus comprising:
means for encoding hardware loop information into one or more bits at one or more reserved bit positions of at least one designated instruction in the set of packets, wherein the at least one designated instruction comprises an instruction that is not used to specify a hardware loop.

26. The apparatus of claim 25 wherein:
the encoded hardware loop information comprises end of hardware loop packet information; and
the at least one designated instruction comprises an instruction that is not used to specify an end packet of the hardware loop.

27. The apparatus of claim 26 wherein:
the end of loop information encoded in a designated instruction of a particular packet indicates that the particular packet is an end packet of the hardware loop or indicates that the particular packet is not an end packet of the hardware loop.

28. The apparatus of claim 25 wherein the hardware loop information is encoded within the bits of the designated instruction so that bits specifying the designated instruction are before and after the bits of the encoded hardware loop information.

29. The apparatus of claim 28 wherein:
each instruction comprises 32 bits;
the hardware loop information is encoded in the 15^{th} and 16^{th} bits of the designated instruction; and
the 1^{st} through 14^{th} bits and the 17^{th} through 32^{nd} bits of the designated instruction specify the designated instruction.

30. The apparatus of claim 25 wherein:
the set of packets are a set of Very Long Instruction Word (VLIW) packets; and
the hardware loop information is encoded into an instruction at a same predetermined position in each VLIW packet of the set of VLIW packets.

31. The apparatus of claim 25 wherein:
the at least one hardware loop comprises a first loop comprising a first set of packets to be executed a particular number of iterations and a second loop comprising a second set of packets to be executed a particular number of iterations;
hardware loop information regarding the first loop is encoded into an instruction at a first predetermined position in each packet of the first set of packets; and
hardware loop information regarding the second loop is encoded into an instruction at a second predetermined position in each packet of the second set of packets.

32. The apparatus of claim 25, further comprising:
means for encoding end instruction information into at least one instruction in the set of packets not having encoded hardware loop information, the end instruction information being encoded in the same bit positions reserved for the encoded hardware loop information, wherein the encoded end instruction information indicates whether an instruction is the last instruction of a packet and indicates the length of a packet.
